(19) United States
(12) Patent Application Publication
(10) Pub. No.: US 2011/0110566 A1
(43) Pub. Date: May 12, 2011

(54) METHOD AND APPARATUS FOR REDUCING IMAGE NOISE

(76) Inventors: Jonathan Sachs, Haifa (IL); Adrian Stern, Omer (IL)

(21) Appl. No.: 12/616,398

(22) Filed: Nov. 11, 2009

(51) Int. Cl. G06K 9/40; G06K 9/00

(52) U.S. Cl. 382/128; 382/254

(57) ABSTRACT

A method and apparatus are provided for reducing noise in a medical diagnostic image. The method includes obtaining an image data set of a region of interest in an object, defining a first area that includes a plurality of pixels surrounding a pixel in the image data set, rotating and reflecting the first area to identify at least one different second area that includes a structure that is similar to a second structure defined in the first area, and generating an image having reduced noise using the rotated and reflected area.

### BACKGROUND OF THE INVENTION

The subject matter disclosed herein relates generally to imaging systems, and more particularly, embodiments relate to an apparatus and methods for reducing noise in images.

At least some known Positron Emission Tomography (PET) imaging systems use count rate correction methods to attempt to accurately determine pulses to improve image quality. A function of a “true count rate” vs. a “measured count rate” may be found experimentally, for example, using a strong radioactive source with a known decay time and measuring the count rate over a long duration, or may be calculated from a theoretical model of the detector, trigger, and counter system. However, such methods only statistically correct the count rate and consequently add noise to the signal.

To account for the statistical noise in the image, conventional imaging systems utilize various techniques to remove the noise and thereby increase the image quality. For example, the length of the scan time may be increased to capture more photons. However, increasing the scan time also increases the dosage to the patient (CT and transmission NM images) or results in patient discomfort and increased vulnerability to patient motion with fixed dosage to patient (PET and single photon emission images). Optionally, the conventional imaging system may utilize various image processing techniques to reduce noise due to the Poisson nature of the acquired counts. For example, imaging systems may use a local computation technique over a spatial, spatial-spatial frequency or a multi-scale domain. In order to better represent edges, imaging systems may use an anisotropic spatial filter, an anisotropic partial differential equation (PDE) filter, and/or “edge preserving” regularization potentials.

Another conventional de-noising technique utilizes a filter that replaces each pixel by a weighted average of all the pixels in the image. However, the conventional filter requires the computation of the weighting terms for all possible pairs of pixels, making it computationally expensive.

### BRIEF DESCRIPTION OF THE INVENTION

In one embodiment, a method for reducing noise in a medical diagnostic image is provided. The method includes obtaining an image data set of a region of interest in an object, defining a first area that includes a plurality of pixels surrounding a pixel in the image data set, translating, rotating and reflecting the first area to identify at least one different second area that includes a structure that is similar to a second structure defined in the first area, and generating an image having reduced noise using the translated, rotated and reflected area.

In another embodiment, a medical imaging system including a computer for reducing noise is a medical diagnostic image is provided. The computer is programmed to obtain an image data set of a region of interest in an object, define a first area that includes a plurality of pixels surrounding a pixel in the image data set, translate, rotate and reflect the first area to identify a plurality of different second areas that each include a structure that is similar to a second structure defined in the first area, and generate an image having reduced noise using the translated, rotated and reflected area.

In a further embodiment, a computer readable medium for reducing noise in a medical diagnostic image is provided. The computer is encoded with a program to instruct the computer to obtain an image data set of a region of interest in an object, define a first area that includes a plurality of pixels surrounding a pixel in the image data set, rotate and reflect the first area to identify a plurality of different second areas that each include a structure that is similar to a second structure defined in the first area, and generate an image having reduced noise using the rotated and reflected area.

### BRIEF DESCRIPTION OF THE DRAWINGS

FIG. 1 is a block schematic diagram of an exemplary imaging system in accordance with an embodiment of the present invention.

FIG. 2 is a flowchart illustrating an exemplary method for reducing noise related imaging artifacts in an image in accordance with an embodiment of the present invention.

FIG. 3 is a flowchart illustrating the operation of an exemplary noise-reducing filter in accordance with an embodiment of the present invention.

FIG. 4 is a schematic illustration of an exemplary image data set in accordance with an embodiment of the present invention.

FIG. 5 is an exemplary area shown in a rectangular coordinate system in accordance with an embodiment of the present invention.

FIG. 6 is the exemplary area shown in FIG. 5 transformed into a polar coordinate system in accordance with an embodiment of the present invention.

FIG. 7 illustrates a plurality of pixels selected in accordance with an embodiment of the present invention.

FIG. 8 is a picture having reduced noise generated in accordance with various embodiments of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated but a viewable image is not. Therefore, as used herein the term “image” broadly refers to both viewable images and data representing a viewable image. However, many embodiments generate, or are configured to generate, at least one viewable image.

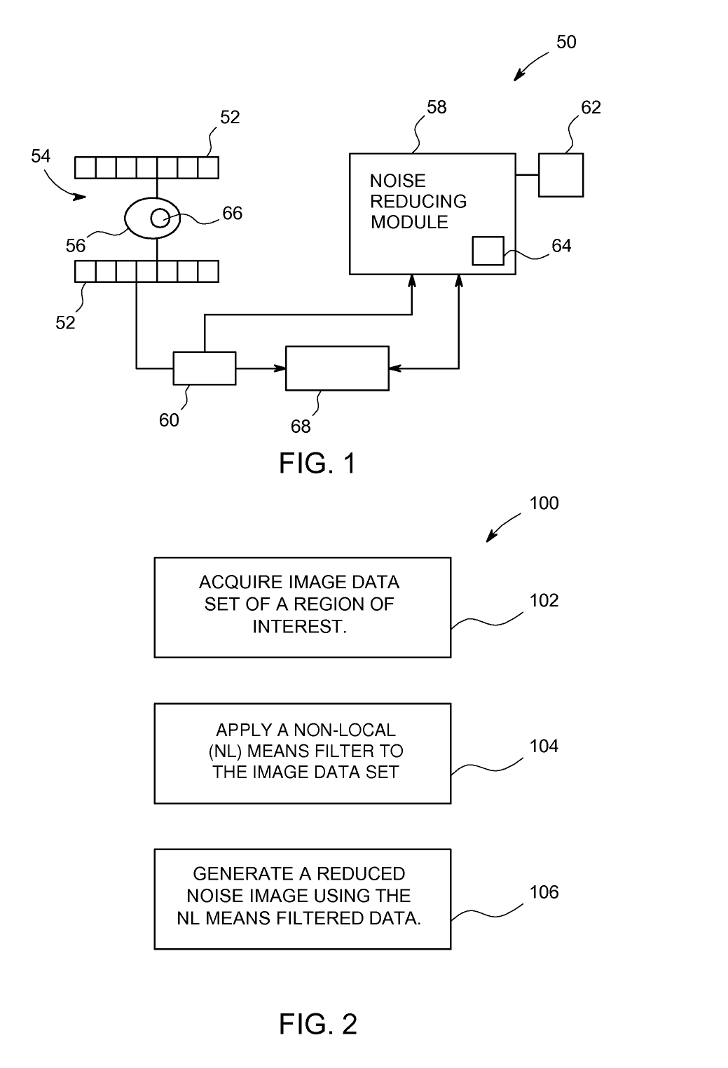

FIG. 1 is a schematic block diagram of an exemplary imaging system 50 in accordance with an embodiment of the present invention. The imaging system 50 includes a pair of detectors 52 having a central opening 54 therethrough. The opening 54 is configured to receive an object or patient, such as object 56 therein. The imaging system 50 also includes a noise-reducing module 58. The noise-reducing module 58 may be implemented on a computer 68 that is coupled to the imaging system 10. Optionally, the noise-reducing module 58 may be implemented as a module or device that is coupled to or installed in the computer 68. During operation, the output from the detector 52, referred to herein as an image data set 60, raw image data, or an emission data set, is transmitted to the noise-reducing module 58. The noise-reducing module 58 is configured to utilize the image data set 60 to identify and remove noise related imaging artifacts from the image data set 60 to form a reduced noise image 62. More specifically, in the exemplary embodiment, the noise reducing module 58 utilizes a translation, rotational, reflected-rotational invariant non-local (TRRRINL) filter 64 that is programmed to filter the image data set 60 to reduce noise in the image as discussed in more detail below. In the exemplary embodiment, the TRRRINL filter 64 is implemented as a set of instructions or an algorithm that is installed on the noise reducing module 58. Optionally, the TRRRINL filter 64 may be a set of instructions or an algorithm that is installed on any computer that is coupled to or configured to receive the image data set 60, e.g. a workstation coupled to and controlling the operation of the imaging system 50. During operation, the TRRRINL filter 64 is configured to improve the image quality acquired during a short duration scan to the same proximate quality of an exemplary image data set acquired during a longer scan.

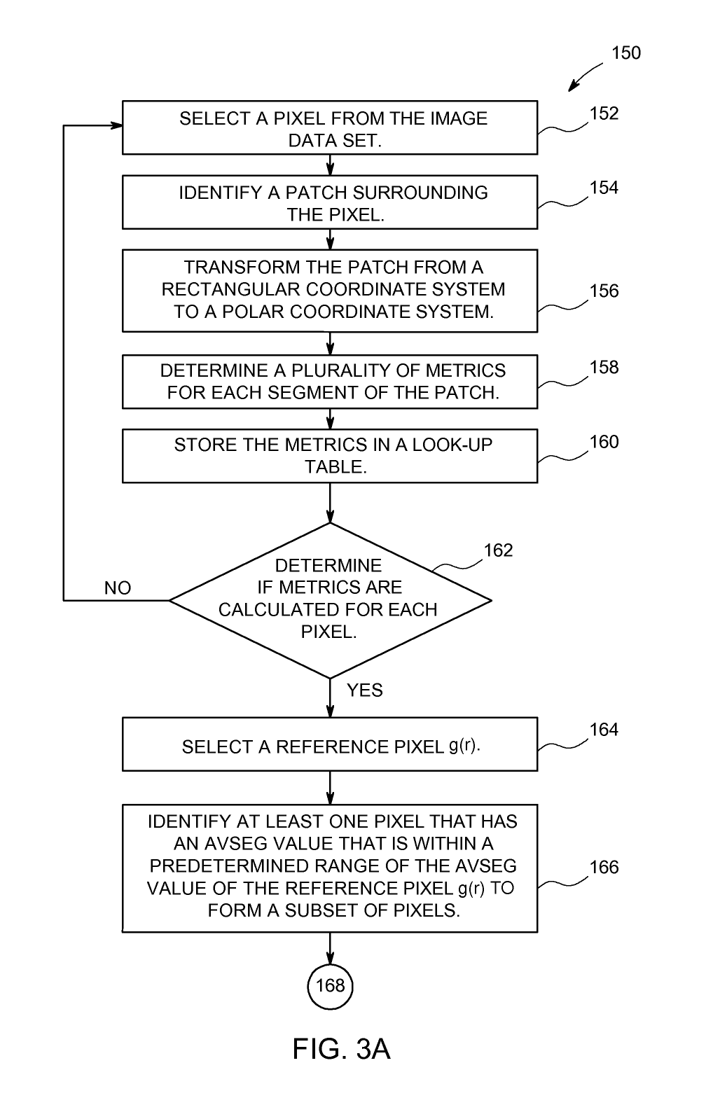

FIG. 2 is a simplified block diagram of an exemplary method 100 for reducing, in an image, noise related imaging artifacts. The method 100 may be performed by the exemplary noise-reducing module 58 shown in FIG. 1. The method 100 performs image noise reduction on the image data set 60 to account for noise related imaging artifacts. More specifically, the method 100 identifies the noise related imaging artifacts and re-organizes the image data set 60 to enable an image, having reduced noise, of the object 56 to be reconstructed.

In one embodiment, the noise-reducing module 58 is installed in a medical imaging system such as, a gamma camera system for 2D images. Optionally, the noise-reducing module 58 may be installed in a Computed Tomography (CT) imaging system, a Positron Emission Tomography (PET) imaging system, or a Single photon emission computed tomography (SPECT) imaging system. Optionally, the noise-reducing module 58 may be installed in a digital camera, a computer, or any other device capable of generating digital images. In the exemplary embodiment, the image data set 60 is an emission data set obtained from a PET or SPECT imaging system. The method 100 may be applicable to any two-dimensional (2D), three-dimensional (3D), or four-dimensional (4D) image or image data set that includes Poisson noise.

At 102, an image data set, e.g. image data set 60, of a region of interest 66 (shown in FIG. 1) of the object 56 is obtained. In the exemplary embodiment, the image data set 60 is acquired and utilized by the noise-reducing module 58 in substantially real-time, for example while the imaging system 50 is acquiring image data. Optionally, the noise-reducing module 58 may access stored data, e.g. list mode data, to generate the reduced noise image 62.

At 104 a filter is applied to the image data set 60. In one embodiment, the filter is embodied as a device that includes a set of instructions or an algorithm that is installed on the device. In the exemplary embodiment described herein, the filter is embodied as a set instructions on the noise-reducing module 58 discussed above. In the exemplary embodiment, the filter is the TRRRINL filter 64 that is expressed mathematically as:

$$TRRRINL \{ g ( r ) \} = {\sum }_{t} w ( r , t ) g ( t ) , \\ 0 \leq w ( r , t ) \leq 1 , \\ {\sum }_{∀ t} w ( r , t ) \qquad ( 3 )$$

where:

g(r) is a pixel being filtered, referred to herein as a reference pixel;

g(t) is a test pixel being used to denoise the reference pixel g(r); and

w(r,t) is a weight assigned to the intensity value of the test pixel g(t) for restoring the reference pixel g(r).

At 106, the noise-reducing module 58 is configured to generate a reduced noise image 62 using the image data processed by the TRRRINL filter 64.

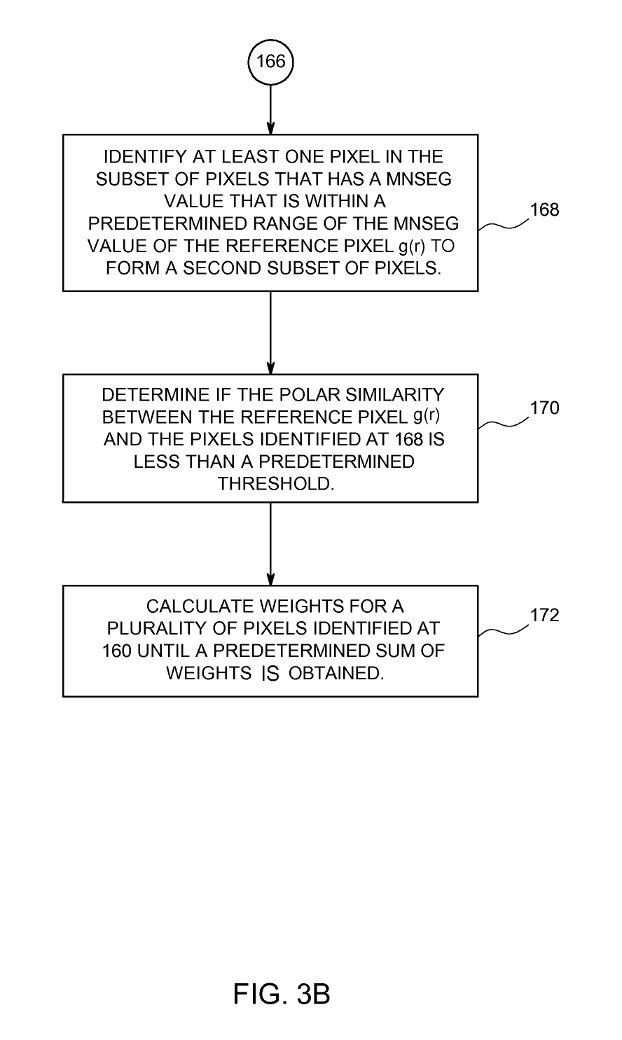

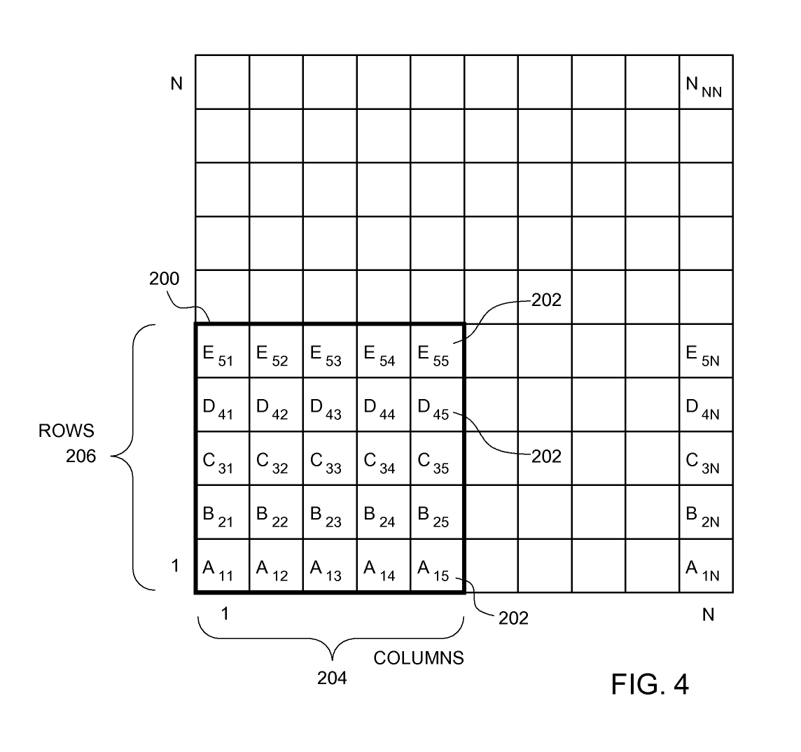

FIG. 3 is a flowchart illustrating an exemplary method 150 implemented by the TRRRINL filter 64. FIG. 4 is a schematic illustration of the exemplary image data set 60. The image data set 60 may be of any size. For example, the image data set 60 may be a 128×128 matrix of pixels, a 256×256 matrix of pixels, or any other size image. Referring again to FIG. 3, at 152, the TRRRINL filter 64 selects a pixel from the image data set 60. For example, the TRRRINL filter 64 may select pixel c₃₃ shown in FIG. 4. At 154, the TRRRINL filter 64 identifies a plurality of pixels surrounding the selected pixel (c_{33.}) to define a neighborhood or area 200 that surrounds the pixel c₃₃.

For example, FIG. 4 is a graphical illustration of an exemplary area 200 that is defined around the pixel c₃₃. In the exemplary embodiment, the area 200 is defined as a five-by-five matrix surrounding the pixel c₃₃ having a fixed size and centered at the pixel c₃₃. Optionally, the area 200 may have a size that includes greater than or fewer than twenty-five pixels. As shown in FIG. 4, the area 200 has a length 204 and width 206 that is the same as the length 204. In the exemplary embodiment, the width and length 204 and 206 are equal to five such that the area 200 includes twenty-five pixels including twenty-four pixels 202 and the pixel c₃₃. Optionally, the area 200 may include nine total pixels, e.g. eight pixels 202 surrounding the pixel c₃₃. Optionally, the area 200 may include forty-nine or more pixels 202.

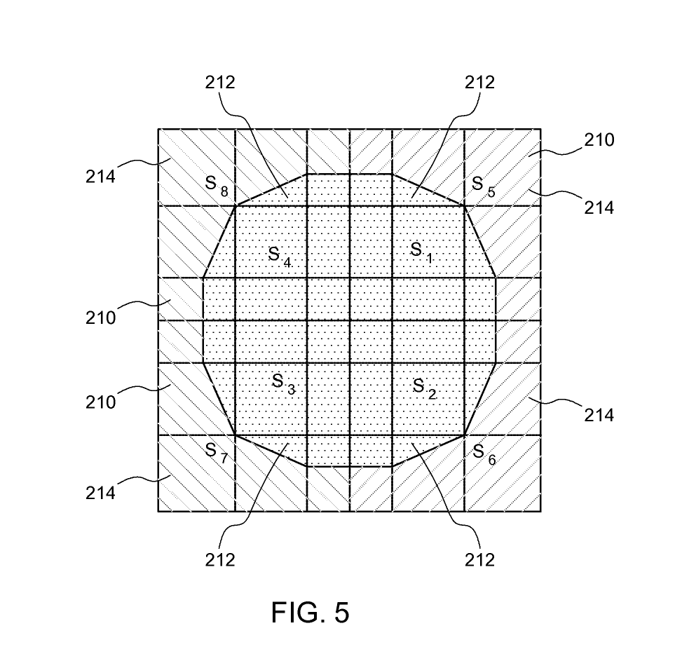

Referring again to FIG. 3, at 156, the TRRRINL filter 64 transforms the area 200 defined in step 154 from a rectangular coordinate system (shown in FIG. 4) to a polar coordinate system shown in FIG. 5. Transforming the area 200 from a rectangular coordinate system to a polar coordinate system facilitates reducing the quantity of information being processed by the TRRRINL filter 64 to identify similar areas as is discussed in more detail below.

FIG. 5 illustrates the exemplary area 200 transformed into polar coordinates. As discussed above, in the exemplary embodiment the area 200 is sized to include twenty-five pixels (5×5). The twenty-five pixel area 200 is then transformed into a polar coordinate system that includes a plurality of segments 210. In the exemplary embodiment, the quantity of segments 210 is less than the quantity of pixels in the area 200. For example, the exemplary area 200 includes twenty-five pixels. The TRRRINL filter 64 transforms the twenty-five pixels from a rectangular coordinate system to a polar coordinate system that includes eight segments 210 shown as segments S₁, S₂, S₃, S₄, S₅, S₆, S₇, and S₈. As shown in FIG. 5, the area 200 includes four inner segments 212 and four radially outer segments 214 each having substantially the same area as the four inner segments 212. It should be realized that the 2D data representation conversion described above can be extended to 3D images by using similarly defined spherical-like coordinates.

Referring again to FIG. 3, at 158 the TRRRINL filter 64 determines a plurality of metrics for each segment 210 of the area 200. More specifically, in the exemplary embodiment, the TRRRINL filter 64 determines at least some of the following metrics for each segment 210. The metrics may include the pixel count (pixcnt) for each respective segment, the average of the pixels counts for each of the respective eight segments 210, Avseg1, Avseg2, Avseg3, Avseg4, Avseg5, Avseg6, Avseg7, and Avseg8. The metrics may also include the combined averages or mean of all the individual segment averages. For example, Avseg=Avseg1+Avseg2+Avseg3+Avseg4+Avseg5+Avseg6+Avseg7+Avseg8. The metrics may also include the variance (Vseg). The variance (Vseg) is the weighted sum of the individual segments averages squared.

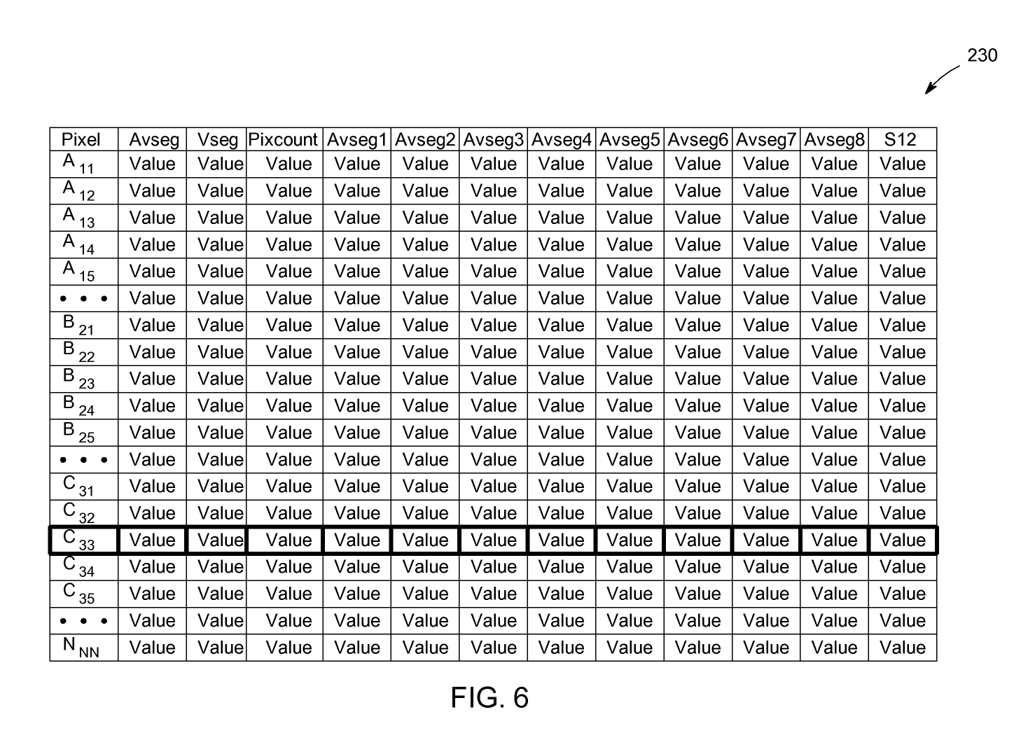

At 160, the metrics determined at 158 are stored in a look-up table 230. FIG. 6 illustrates an exemplary look-up table 230, generated in accordance with various embodiments described herein, to store the metrics determined at 158. During operation, the TRRRINL filter 64 is configured to determine the metrics for each pixel in the image data set 60 and then store the metrics in the look-up table 230. More specifically, the TRRRINL filter 64 iteratively processes each pixel in the image data set 60 using the method outlined in steps 152-160.

At 162, The TRRRINL filter 64 determines if the metrics have been calculated for each pixel in the image data set 60 as described above with respect to steps 152-160. If the TRRRINL filter 64 determines that metrics have been calculated and stored in the look-up table 230 for each pixel in the image data set 60, the method proceeds to 164. Optionally, if the TRRRINL filter 64 determines that metrics have not been calculated and stored in the look-up table 230 for each pixel in the image data set 60, the method proceeds back to method step 152. At 152, the TRRRINL filter 64 selects a subsequent pixel, determines the metrics for the subsequent pixel, and stores the metrics in the look-up table 230 as outlined in steps 152-160. As a result, when all the metrics have been calculated for each pixel in the image data set 60, or a subset of interest therein, the table 230 will include a value for each identified metric for each pixel and each pixel segment.

At 164, the TRRRINL filter 64 is configured to select a reference pixel g(r) from the look-up table 230. The first reference pixel may be selected as the first pixel in the image, for example, pixel a₁₁. Optionally, any pixel may be selected as the reference pixel. It should be realized that the following method is an iterative method that is applied to each pixel in the image data set 60 and thus applied to each pixel in the look-up table 230. More specifically, each pixel in the image data set 60 will be identified as a reference pixel at some point in the method.

At 166, the TRRRINL filter 64 identifies at least one other pixel, and preferably a plurality of pixels that have an Avseg that is within a predetermined range of the Avseg of the reference pixel g(r). More specifically, as discussed above, the metrics for each pixel in the image, including the g(r), Avseg value are stored in the table 230. Therefore, the TRRRINL filter 64 initially selects the reference pixel g(r). The TRRRINL filter 64 then selects the Avseg value for the reference pixel g(r) from the table 230. Based on the Avseg value of the reference pixel g(r), the TRRRINL filter 64 performs a first pre-filtering of the image data set 60. [symbol] the first pre-filtering operation, the TRRRINL filter identifies each pixel within the image [symbol] set 60 having an Avseg value that is within a predetermined range of the Avseg value of the reference pixel g(r) using a method referred to herein as a “windowing” method.

The first pre-filtering or “windowing” operation is performed in accordance with according the average is performed as follows:

S_{Av}[r]−ασ_{S}_{_{Av}}_{[r]}≦S_{Av}[t]≦S_{Av}[r]+ασ_{S}_{_{Av}}_{[r]} (7)

where S_{AV}[r], S_{AV}[t] denotes the average of the segments in the reference area Wᵣ, where the reference area is the area surrounding the reference pixel g(r) identified at 154. Wᵣ, is the area surrounding an exemplary test pixel. σ_{S}_{_{AV}}_{[r]} is the standard deviation of _{S}_{_{AV}}_{[r]} due only to noise (i.e., assuming same structure), and α is a controlling parameter. For Poisson noise _{S}_{_{AV}}_{[r]} is then given by:

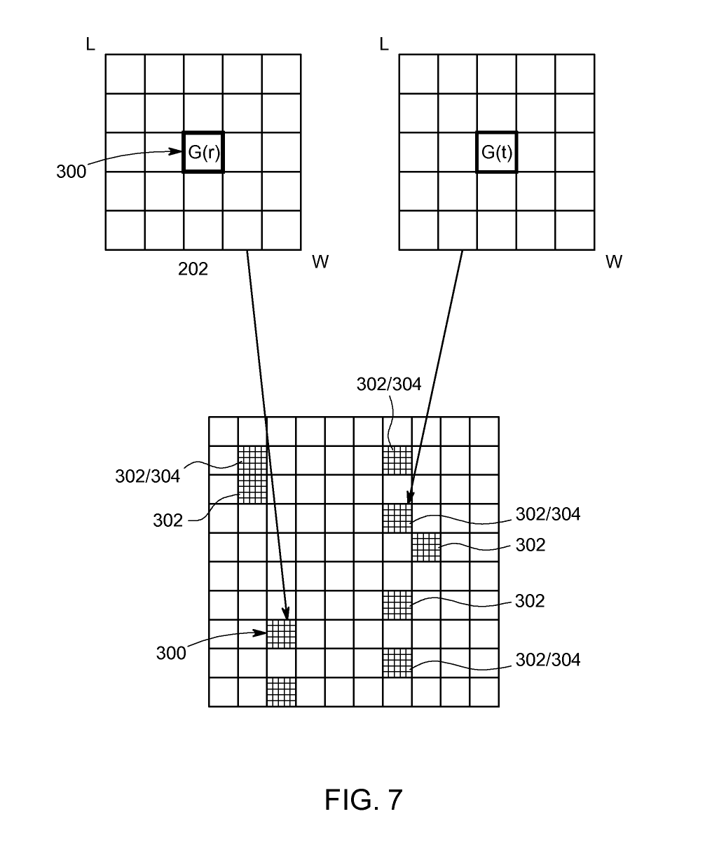

σ_{S}_{_{Av}}_{[r]}=\sqrt{K₁S_{Av}}, (8)

where K₁ is a parameter defined by the transform from pixel (rectangular) to segments (polar representation), that is, the weighting of the pixels shown in FIG. 7. K₁ can then be approximated by:

$${K}_{1} = \frac{1}{64} {\sum }_{i , j = 0}^{24} {a}_{i , j}^{2} \qquad ( 9 )$$

where aij are the weights of pixels used to perform rectangular to polar transformation. FIG. 7 illustrates an exemplary reference pixel 300 selected at 166 described above. FIG. 7 also illustrates a plurality of pixels 302 selected at 166 described above. The pixels 302 each have an Avseg value that is within the predetermined range of the reference pixel Avseg value.

Referring again to the method 150 shown in FIG. 3, at 168 the TRRRINL filter 64 identifies at least one other pixel, and preferably a plurality of pixels that have a Vseg that is within a predetermined range of the Vseg of the pixels identified at 166. More specifically, as discussed above, the TRRRINL filter 4 first filters all of the pixels in the image data set 60 to identify a subset of pixels (pixels 302) having Avseg that is within the predetermined range of the reference pixel g(r) to form a first subset of pixels. The TRRRINL filter 64 then selects the Vseg value for the reference pixel g(r) from the table 230. Based on the Vseg value of the reference pixel g(r), the TRRRINL filter 64, at 168 performs a second pre-filtering of the subset of pixels 302 identified at 166. During the second pre-filtering operation, the TRRRINL filter identifies each pixel within the subset of pixels 302 having a Vseg value that is within a predetermined range of the Vseg value of the reference pixel g(r) using a method referred to herein as a second “windowing” or pre-filtering method.

The second pre-filtering of the subset of pixels 302 is performed by the TRRRINL filter 64 in accordance with:

$$Var \{ {S}_{ref} \} - T\_var {σ}_{Var \{ {S}_{ref} \}} \leq Var \{ {S}_{test} \} \leq Var \{ {S}_{ref} \} + T\_var {σ}_{Var \{ {S}_{ref} \}} \qquad ( 10 )$$

where Var{S_{ref}}=Var{S₁[r]}⁸ᵢ₌₁ is the variance of the segments surrounding the reference pixel g(r) and T_var is a controlling parameter and Var{Sₜₑₛₜ}=Var{S₁[r]}⁸ᵢ₌₁ is the variance of the segments surrounding the tested pixel t. σ_{Var{Sref}} is the standard deviation of the variance of the variance Var{S_{ref}}. For Poisson noise σ_{Var{Sref}} can then be expressed by:

$${σ}_{Var \{ {S}_{ref} \}} = {A}_{1} {〈 n 〉}_{W} + {A}_{2} {〈 n 〉}_{W}^{2} + {A}_{3} {〈 n 〉}_{W}^{3}$$

where <n>_{W} is the pixel average in the area W, and A₁, A₂ and A₃ are parameters determined by the kernels used to generate 8 segments from the 5*5 surrounding pixel space. Referring again to FIG. 7, FIG. 7 illustrates a plurality of pixels 304 selected at 168 described above. The pixels 304 each have an Avseg value that is within the predetermined range of the reference pixel 300 Avseg value and also have a Vseg value that is within the predetermined range of the reference pixel 300 Vseg value.

As discussed above, performing an exhaustive search of all neighbors surrounding a given pixel is computationally expensive. Therefore, to reduce the computational burden on the TRRRINL filter 64, only the potential filtering partners are pre-selected, e.g. pixels 304, using tests on the surrounding area average S_{AV}, and on the variance of polar coefficients {Sᵢ} as discussed above at 166 and 168. At 170, the TRRRINL filter 64 determines if the polar similarity between the reference pixel g(r) and the pixels 304 is less than a predetermined threshold. More specifically, to enable the TRRRINL filter 64 to weight each of the pixels 304 as discussed in more detail below, the TRRRINL filter first determines the polar similarity using the segments 210 shown in FIG. 5, wherein the vectors of the inner segments 212 (shown in FIG. 5) is Sin=[S₁,S₂,S₃,S₄]^{T} and the outer vectors of segments 214 are represented mathematically as Sout=[S₅,S₆,S₇,S₈]^{T}.

Using this notation, the weights for each pixel 304 are determined in accordance with:

$${dS}^{2} ( r , t ) = min \{ \begin{matrix}{min}_{k} [ {‖ Sin [ r ] - Rot ( Sin [ t ] , k ) ‖}^{2} + {‖ Sout [ r ] - Rot ( Sout [ t ] ) ‖}^{2} ] , \\ {min}_{k} [ {‖ Sin [ r ] - Rot ( Rfl ( Sin [ t ] ) , k ) ‖}^{2} + {‖ Sout [ r ] - Rot ( Rfl ( Sout [ t ] ) , k ) ‖}^{2} ]\end{matrix} \} , \qquad ( 6 )$$

where θ=k90°, k=0,1,2,3.

In the exemplary embodiment, weight dS² is the L₂ norm between the area surrounding the reference pixel g(r) and the area surrounding the test pixel g(t) after rotation or reflection and rotation, to yield best match, and

Rfl is the reflection operator, Rfl{[S₁,S₂,S₃,S₄]}=[S₄,S₃,S₂,S₁]

Rot is the rotation operator, Rot(A, k) k=0 . . . 3 Rot[S₁,S₂,S₃,S₄], 1}=[S₂,S₃,S₄,S₁]; and

β is a damping parameter.

The L₂ norm represents a normalization between the area surrounding the reference pixel and the area surrounding the text pixel. The L₂ represents a correlation between the reference area and the test area. More specifically, if the structure within the reference area is substantially similar to the structure in the test area, the L₂ norm is high. If the structure within the reference area is different than the structure in the test area, the L₂ norm is relatively low.

In the exemplary embodiment, the L₂ norm dS² is expressed mathematically as:

$${dS}^{2} ( r , t ) = min \{ {min}_{θ} {‖ {W}_{r} - Rot ( {W}_{t} , θ ) ‖}^{2} , {min}_{θ} {‖ {W}_{r} - Rot \{ Rfl ( {W}_{t} , θ ) \} ‖}^{2} \} \qquad ( 5 )$$

where:

Wᵣ is the reference area 200;

Wₜ is the test area 300/302;

Rfl is the rotational reflection of Wₜ; and

Rot(W, θ) is a rotation operator of the test neighborhood Wₜ by an angle θ (for images having a dimension that is larger than 2θ in a vector rotation angles).

The denominator in the exponent in (2) determines the mean of the nominator; 2O˜4=E[dS2(r,t)j, under Null Assumption, that is the mean of dS²(r,t) assuming that the structures around r and t are similar and that differences arise only due the noise realization.

In one embodiment, the L₂-norm dS² (r,t) may be calculated as rectangular coordinates as a Cartesian representation. In the exemplary embodiment, the L₂-norm dS² (r,t) is calculated in polar or polar-like representations as shown in FIG. 5. Calculating the L₂-norm dS² (r,t) in polar coordinates reduces the quantity of calculations performed by the TRRRINL filter 64. Specifically, as described above, the TRRRINL filter 64 takes each segment in the identified areas, rotates and reflects the segments to identify similar areas having a similar structure, for example a bone or rib. Therefore, the method described above identifies each area, the test areas) that is similar to the reference area regardless of whether the test areas are rotated or reflected when compared to the reference area.

Referring again to the method 150 shown in FIG. 3, at 172, after similar test areas have been identified, the weights are calculated for the test areas until a predetermined sum of weights of obtained. More specifically, a weight w(r,t) is calculated for a first pixel 304 in accordance with:

$$w ( r , t ) = \frac{1}{c ( r )} {e}^{- β \frac{{dS}^{2} ( r , t )}{2 {σ}_{NA}^{2}}} , c ( r ) = {\sum }_{∀ t} w ( r , t ) \qquad ( 4 )$$

where:

r is a pixel being filtered, referred to herein as a reference pixel;

t is a test pixel being used to denoise the reference pixel g(r); and

σ is a standard deviation.

A weight w(r,t) is then calculated for a subsequent pixel 304. When the total quantity of weights is equal to a predetermined value, e.g. Sum_Weight=predetermined value, the TRRRINL filter 64 stops calculating the weights discussed above. The weights described above are then used to estimate a pixel intensity of the reference pixel g(r) in accordance with:

$$TRRRINL \{ g ( r ) \} = {\sum }_{t} w ( r , t ) g ( t ) , \\ 0 \leq w ( r , t ) \leq 1 , \\ {\sum }_{∀ t} w ( r , t ) \qquad ( 3 )$$

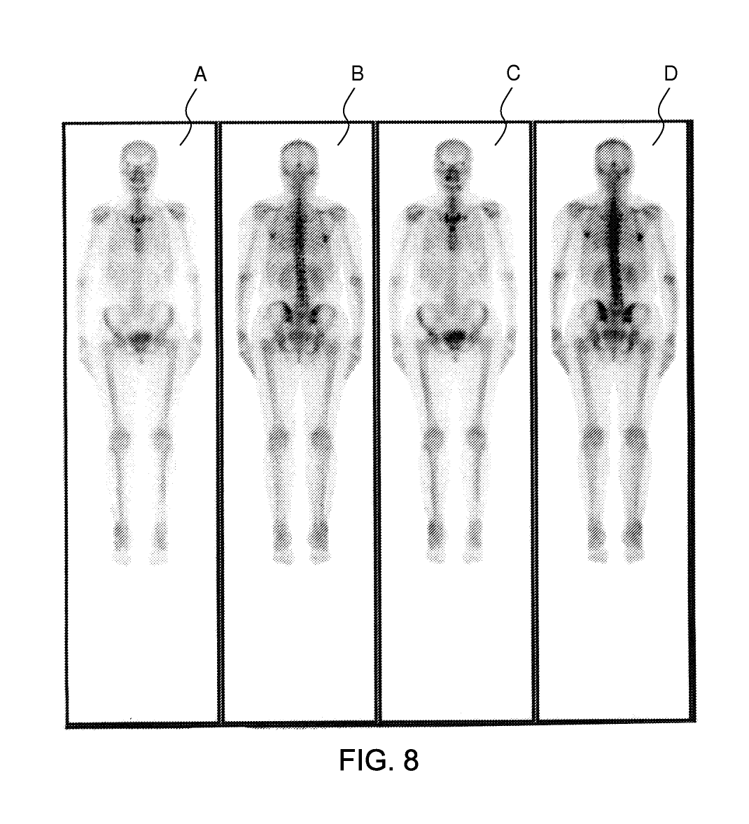

FIG. 8 illustrates an exemplary reduced noise image 62 that illustrates an exemplary reference area and a plurality of test areas that are similar to the reference area. As shown in FIG. 8, images a and b are anterior and posterior images, respectively prior to utilizing the various methods described herein. Images c and d are the anterior and posterior images shown in a and b after performing noise correction utilizing the various methods described herein.

A technical effect of the various embodiments described herein is to provide an automatic method of characterizing and reducing imaging noise in nuclear medicine images. Specifically, the methods described herein include techniques for removing noise from images by using the concept of non-local processing. The methods identify similarity of structures, e.g. bones) under a translation operation and also the similarity of the same structures under rotation and reflection. The methods described herein are applicable on any dimensional data (in particular to 2D and 3D images) corrupted by arbitrary noise. Special considerations for de-noising images including Poisson noise are derived.

Various embodiments of the methods described herein rotate and reflect only a potion of the pixels in an image data set to determine the L2 norm for calculating the weights to determine the similarity. To determine which pixels are weighted, each of the pixels in the image data set are first pre-filtered to select pixels having an average segment value that is substantially similar to a reference pixel. The pixels are then pre-filtered a second time to select pixels having a mean segment value that is substantially similar to the mean segment value of the reference pixel. Only pixels having an average segment value and an average mean value that are substantially similar the average segment value and mean value of a reference pixel are weighted to reduce computation time. Segmenting the areas facilitates enabling the TRRRINL filter 64 to rotate and reflect each area to identify similar areas in the image data set. Specifically, the methods described herein rotate and reflect each segment to identify other segments having the same pixel residing in a similar area having a similar structure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

Some embodiments of the embodiments described herein may be implemented on a machine-readable medium or media having instructions recorded thereon for a processor or computer to operate an imaging apparatus to perform an embodiment of a method described herein. The medium or media may be any type of CD-ROM, DVD, floppy disk, hard disk, optical disk, flash RAM drive, or other type of computer-readable medium or a combination thereof.

The various embodiments and/or components, for example, the monitor or display, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for reducing noise in a medical diagnostic image, said method comprising:
obtaining an image data set of a region of interest in an object;
defining a first area, that includes a plurality of pixels surrounding a central pixel, in the image data set;
rotating and reflecting the first area to identify at least one different second area that includes a structure that is similar to a second structure defined in the first area; and
generating an image having reduced noise using the rotated and reflected area.

2. The method in accordance with claim 1 further comprising applying a non-local filter to the first area to identify the second area.

3. The method of claim 1 further comprising translating the first area from a rectangular coordinate system to a polar coordinate system to identify the second area.

4. The method of claim 1 further comprising:
storing a plurality of metrics for each pixel in the image data set in a table; and
utilizing the table to identify the second area.

5. The method of claim 1 further comprising:
storing a plurality of metrics for each pixel in the image data set in a table; and
pre-filtering the metrics based on a segment average (Avseg) of the first area identify the second area.

6. The method of claim 1 further comprising:
storing a plurality of metrics for each pixel in the image data set in a table; and
pre-filtering the metrics based on a segment variance (Vseg) of the first area to identify the second area.

7. The method of claim 1 further comprising:
storing a plurality of metrics for each pixel in the image data set in a table; and
determining the average and the variance of the first area to identify the second area.

8. The method of claim 1 further comprising determining if the polar similarity between the first area and the second area is less than a predetermined threshold.

9. The method of claim 8 further comprising determining an L₂ norm between the first area and the second area after rotation or reflection and rotation, to yield best match.

10. The method of claim 8 further comprising calculating weights for a plurality of second areas until a predetermined sum of weights of obtained.

11. A medical imaging system comprising a computer for reducing noise is a medical diagnostic image, said computer is programmed to:
obtain an image data set of a region of interest in an object;
define a first area that includes a plurality of pixels surrounding a pixel in the image data set;
rotate and reflect the first area to identify a plurality of different second areas that each include a structure that is similar to a second structure defined in the first area; and
generate an image having reduced noise using the rotated and reflected area.

12. A medical imaging system in accordance with claim 11 wherein the computer is further programmed to apply a non-local filter to the first area to identify the second areas.

13. A medical imaging system in accordance with claim 11 wherein the computer is further programmed to translate the first area and the second areas from a rectangular coordinate system to a polar coordinate system.

14. A medical imaging system in accordance with claim 11 wherein the computer is further programmed to:
store a plurality of metrics for each pixel in the image data set in a table; and
utilize the table to identify the second areas.

15. A medical imaging system in accordance with claim 11 wherein the computer is further programmed to:
store a plurality of metrics for each pixel in the image data set in a table;
pre-filtering the metrics based on a segment average (Avseg) of the first area to generate a first subset of pixels; and
pre-filtering the first subset of pixels based on a variance (Vseg) of the first area to identify the second areas.

16. A medical imaging system in accordance with claim 11 wherein the computer is further programmed to determine if the polar similarity between the first area and the second areas is less than a predetermined threshold.

17. A medical imaging system in accordance with claim 11 wherein the computer is further programmed to determine an L₂ norm between the first area and the second areas after the first area has been rotated and reflected.

18. A computer readable medium for reducing noise in a medical diagnostic image, the computer readable medium being programmed to instruct a computer to:
obtain an image data set of a region of interest in an object;
define a first area that includes a plurality of pixels surrounding a pixel in the image data set;
rotate and reflect the first area to identify a plurality of different second areas that each include a structure that is similar to a second structure defined in the first area; and
generate an image having reduced noise using the rotated and reflected area.

19. A computer readable medium in accordance with claim 17 wherein the program further instructs the computer to:
translate the first area and the second areas from a rectangular coordinate system to a polar coordinate system;
store a plurality of metrics for each pixel in the image data set in a table; and
utilize the table to identify the second areas.

20. A computer readable medium in accordance with claim 17 wherein the program further instructs the computer to determine if the polar similarity between the first area and the second areas is less than a predetermined threshold.
